(19) United States
(12) Patent Application Publication
(10) Pub. No.: US 2014/0175006 A1
(43) Pub. Date: Jun. 26, 2014

(54) METHOD OF PREPARING COMPOSITE MEMBRANE MODULE

(71) Applicant: Cheil Industries Inc., Gumi-si (KR)

(72) Inventors: Young Hun Kim, Uiwang-si (KR); Joon Khee Yoon, Uiwang-si (KR)

(73) Assignee: Cheil Industries Inc., Gumi-si (KR)

(21) Appl. No.: 14/139,844

(22) Filed: Dec. 23, 2013

(30) Foreign Application Priority Data
Dec. 24, 2012 (KR) 10-2012-0152625

(51) Int. Cl. B01D 71/68; B01D 69/12

(52) U.S. Cl. CPC B01D 71/68; B01D 69/12; B01D 69/125
USPC 210/490; 427/244

(57) ABSTRACT

A method of preparing a composite membrane module includes preparing a single membrane module to which a hollow fiber support layer is potted; and forming an active layer on a surface of the hollow fiber support layer through interfacial polymerization by bringing a surface of the hollow fiber support layer into contact with a first solution comprising an amine and a second solution comprising an acyl halide (in that order). The method can form an active layer having a uniform thickness and good processability. A composite hollow fiber membrane module prepared by the method exhibits a good salt rejection rate.

### CROSS-REFERENCE TO RELATED APPLICATIONS

This application claims priority to and the benefit of Korean Patent Application No. 10-2012-0152625, filed on Dec. 24, 2012 in the Korean Intellectual Property Office, the entire content of which is incorporated herein by reference.

### BACKGROUND

1. Field

Aspects according to embodiments of the present invention relate to a method of preparing a composite membrane module. For example, aspects according to embodiments of the present invention relate to a method of preparing a composite membrane module using a single membrane module provided with a hollow fiber support layer.

2. Description of the Related Art

Recently, membrane techniques have been applied to water treatment. For example, microfiltration (MF) membranes and ultrafiltration (UF) membranes have been used in water treatment at water purification plants, and reverse osmosis membranes have been used in desalination of seawater. Moreover, reverse osmosis membranes and nanofiltration membranes have been used in water treatment for semiconductor preparation, boilers and medical use, and in purification of water for laboratory use. Water treatment techniques using such membranes are advantageous due to their low treatment cost and good treatment capacity per unit volume.

Recently, unlike other membrane separation processes, such as microfiltration, ultrafiltration, reverse osmosis, nanofiltration and the like, which generate water permeation by applying pressure, a forward osmosis (FO) process, which uses a difference in osmotic pressure between separation membranes as a driving force for generating water permeation, has attracted attention as a novel water treatment process. Forward osmosis performs water treatment using osmotic pressure as a driving force and, thus, requires less energy than the other processes that use pressurization as a driving force.

Since a composite membrane exhibiting improved performance was developed in the early 1980s, single membranes have been replaced by polyamide composite membranes in about 90% of the reverse osmosis membrane market.

A polyamide composite membrane is a composite membrane including a porous support layer formed of a polysulfone polymer resin and a polyamide active layer as a surface selection layer on the porous support layer. The polyamide active layer can be formed by methods such as thin layer dispersion, dip coating, vapor phase deposition, Langmuir-Blodgett deposition, interfacial polymerization, and the like. In addition, for reverse osmosis composite membranes currently developed and commercialized in the art, an interfacial polymerization method such as that disclosed in U.S. Pat. No. 4,277,344, the entire content of which is herein incorporated by reference, can be used as a method of preparing a composite membrane.

As described above, the composite membrane includes a support layer and an active layer formed on the support layer. A composite membrane module is generally prepared by preparing a composite membrane, followed by potting the prepared composite membrane to a header of the module. However, since a hollow fiber type porous support layer has a cylindrical shape, formation of the active layer by coating to a uniform thickness onto such a support layer is difficult due to the structural characteristics of the support layer. Additionally, the active layer has poor processability, because the active layer must be formed by individually coating a great (or large) number of bundles of support layers.

### SUMMARY

According to an embodiment of the present invention, a method of preparing a composite membrane module includes: preparing a single membrane module including a hollow fiber support layer potted therein; and forming an active layer on a surface of the hollow fiber support layer through interfacial polymerization by bringing the surface of the hollow fiber support layer into contact with a first solution including an amine and a second solution including an acyl halide (in that order). Here, the method can form the active layer to a uniform thickness and exhibits good processability, and a composite hollow fiber membrane module prepared by the method exhibits a good salt rejection rate.

In accordance with one aspect according to an embodiment of the present invention, a method of preparing a composite membrane module includes: preparing a single membrane module including a hollow fiber support layer potted therein; and forming an active layer on a surface of the hollow fiber support layer through interfacial polymerization by bringing the surface of the hollow fiber support layer into contact with a first solution including an amine and a second solution including an acyl halide (in that order).

The single membrane module may include a plurality of hollow fiber support layers each being potted at two ends thereof; and a housing receiving the plurality of hollow fiber support layers therein.

The hollow fiber support layer may be prepared by forming hollow fibers by spinning a polymer solution including a polysulfone resin, an organic solvent and a pore agent; forming external pores by exposing the hollow fibers to air; forming internal pores by dipping the hollow fibers having the external pores into a non-solvent; and coagulating the hollow fibers.

The polysulfone resin may include polysulfone, polyether sulfone, or a mixture thereof.

The organic solvent may include N,N-dimethylformamide, N-methyl-2-pyrrolidone, dimethyl sulfoxide, dimethylacetamide, or a mixture thereof.

The pore agent may include 2-ethoxyethanol, propionic acid, acetic acid, t-amyl alcohol, 2-methoxyethanol, methanol, ethanol, butanol, isopropyl alcohol, polyethylene glycol, silica, polyvinylpyrrolidone or a mixture thereof.

The non-solvent may include water, methanol, ethanol, isopropanol, or a mixture thereof.

The hollow fiber support layer may have an inner diameter of about 0.1 mm to about 3.0 mm, and a thickness of about 10 μm to about 500 μm.

The hollow fiber support layer may be a porous ultrafiltration membrane having a pore size of about 10 nm to about 100 μm.

The active layer may have a pore size of about 0.001 μm to about 0.0001 μm.

The first solution may include a polyamine and water, and the polyamine may be present in an amount of about 0.1% by weight (wt %) to about 15 wt % based on 100 wt % of the first solution.

The polyamine may include phenylenediamine, cyclohexanediamine, piperazine, or a mixture thereof.

The second solution may include a polyfunctional acyl halide and an organic solvent, and the polyfunctional acyl halide may be present in an amount of about 0.01 wt % to about 5 wt % based on 100 wt % of the second solution.

The polyfunctional acyl halide may include trimesoyl chloride, isophthaloyl chloride, terephthaloyl chloride, 1,3,5-cyclohexane tricarbonyl chloride, 1,2,3,4-cyclohexane tetracarbonyl chloride, 1,3,5-benzenetricarbonyl trichloride or a mixture thereof.

The composite membrane module may be a pressurizing module.

Another aspect according to an embodiment of the present invention relates to a composite membrane module prepared by the method.

The membrane module may have a salt rejection rate of about 90% to about 99.9%.

### BRIEF DESCRIPTION OF THE DRAWINGS

The above and other aspects, features and advantages of embodiments of the present invention will become more apparent by reference to the following detailed description when considered together with the accompanying drawings, in which:

FIG. 1 is a cross-sectional view of a composite membrane module according to one embodiment of the present invention; and

FIG. 2 shows cross-sectional views of composite membranes according to embodiments of the present invention, in which FIG. 2(a) is a cross-sectional view of a composite membrane including an active layer formed on an inner circumferential surface of a hollow fiber support layer, and FIG. 2(b) is a cross-sectional view of a composite membrane including an active layer formed on an outer circumferential surface of a hollow fiber support layer.

### DETAILED DESCRIPTION

Hereinafter, certain embodiments of the present invention will be described with reference to the accompanying drawings. It should be understood that the present invention is not limited to the following embodiments and may be modified in different ways, and that the following embodiments are given to provide a thorough understanding of the invention to those skilled in the art. Likewise, it should be noted that the drawings are not precise in scale and some of the dimensions, such as width, length, thickness, and the like, may be exaggerated for clarity of description in the drawings. Although some elements are illustrated in the drawings for convenience of description, other elements will be easily understood by those skilled in the art and, therefore, may be omitted from the drawings. It should be noted that the drawings are generally described from the viewpoint of the observer. It will be understood that when an element is referred to as being “on” or “under” another element, the element can be directly on or under the other element, or indirectly on or under the other element and an intervening element(s) may also be present therebetween. In addition, it will be understood that the present invention may be modified in different ways by those skilled in the art without departing from the scope of the present invention. Like components are denoted by like reference numerals throughout the drawings. As used herein, the term “single membrane module” refers to a membrane module (e.g., a separation membrane module) in which an active layer is not formed on a surface of a hollow fiber support layer (e.g., a membrane module that includes a sole membrane).

Aspects according to embodiments of the present invention relate to a method of preparing a composite membrane module (e.g., a method of preparing a module provided with a composite membrane) that includes a hollow fiber support layer and an active layer on a surface of the hollow fiber support layer. According to embodiments of the present invention, a method of preparing a composite membrane module includes: preparing a single membrane module including a hollow fiber support layer potted in the single membrane module; and forming an active layer on a surface of the hollow fiber support layer through interfacial polymerization by bringing the surface of the hollow fiber support layer into contact with a first solution including an amine and then bringing the surface into contact with a second solution including an acyl halide (e.g., the contact between the surface and the first and second solutions occurs in the stated order). In the present detailed description, preparation of a single membrane module and preparation of a composite membrane module using the prepared single membrane module will be separately described for convenience.

### Preparation of a Single Membrane Module

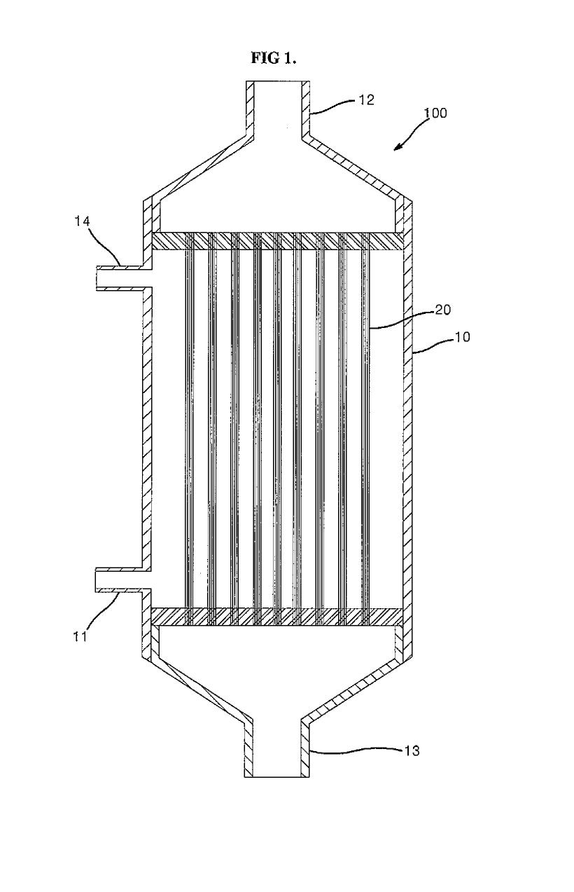

Referring to FIG. 1, a single membrane module 100 according to one embodiment of the invention may include: a plurality of hollow fiber support layers 20, each of the plurality of hollow fiber support layers being potted at two (e.g., both) ends thereof; and a housing 10 accommodating the plurality of hollow fiber support layers 20 therein.

In FIG. 1, the single membrane module is a pressurizing separation membrane module that allows treated water to be collected at two (e.g., both) ends of the module. In the single membrane module, the housing 10 includes a raw water inlet 11 at (or formed at) a lower end of a sidewall thereof; a concentrated water outlet 14 at (or formed at) an upper end of the sidewall thereof; treated water outlets 12, 13 respectively formed at upper and lower ends of the housing 10; and a plurality of hollow fiber support layers 20 potted inside the housing to extend along a longitudinal (or vertical) direction of the housing. In addition to the above-described pressurizing module that collects treated water at two ends, a separation membrane module configured to collect treated water at one end thereof, and an internally or externally pressurizing module may also be used. Additionally, the design and number of raw water inlets, the number and locations of the treated water outlets, or the like may be modified depending on the kinds of pressurizing modules being prepared. According to embodiments of the invention, the pressurizing module is desirably used in view of its coatability, but a dipping separation membrane module may also be used as the single membrane module in addition to the pressurizing separation membrane module.

The hollow fiber support layer may be prepared by a non-solvent induced phase separation process (NIPS). In one embodiment, a method of preparing a hollow fiber support layer may include: forming hollow fibers by spinning a polymer solution including a polysulfone resin, an organic solvent and a pore agent; forming external pores in the hollow fibers by exposing the hollow fibers to air; forming internal pores in the hollow fibers by dipping the hollow fibers having the external pores formed on outer surfaces thereof into a non-solvent; and coagulating the hollow fibers. As used herein, the term “external pores” refers to pores on (or formed on) an outer circumferential surface of a hollow fiber, and the term “internal pores” refers to pores on (or formed on) an inner circumferential surface of a hollow fiber.

The polysulfone resin may include polysulfone, polyether sulfone, or a mixture thereof, but the polysulfone resin is not limited thereto. The polysulfone resin may be present in the polymer solution in an amount of about 10 wt % to about 20 wt % based on the total weight of the polymer solution (e.g., a spinning solution).

The organic solvent may include N,N-dimethylformamide, N-methyl-2-pyrrolidone, dimethyl sulfoxide, dimethylacetamide, or a mixture thereof, but the organic solvent is not limited thereto.

The organic solvent may be present in the polymer solution in an amount of about 60 wt % to about 89 wt %, based on the total weight of the polymer solution (e.g., the spinning solution).

The pore agent may include 2-ethoxyethanol, propionic acid, acetic acid, t-amyl alcohol, 2-methoxyethanol, methanol, ethanol, butanol, isopropyl alcohol, polyethylene glycol, silica, polyvinylpyrrolidone or a mixture thereof, but the pore agent is not limited thereto.

The pore agent may be present in the polymer solution in an amount of about 1 wt % to about 20 wt %, based on the total weight of the polymer solution (e.g., the spinning solution).

The non-solvent may include water, methanol, ethanol, isopropanol, or a mixture thereof, but the non-solvent is not limited thereto.

The non-solvent induced phase separation process (NIPS) can be used to form various structures of a separation membrane, such as a hollow fiber support layer having an asymmetric structure, through various modifications of spinning conditions. Additionally, the non-solvent induced phase separation process (NIPS) has an advantage in that a pore size of the hollow fiber support layer formed using NIPS can be easily adjusted using various additives.

The prepared hollow fiber support layer may be an ultrafiltration membrane, and the pores on (or formed on) a surface of the hollow fiber support layer may have a size of about 10 μm to about 100 μm.

The hollow fiber support layer may have a thickness of about 10 μm to about 500 μm, and an inner diameter of about 0.1 mm to about 3.0 mm, and an outer diameter (OD) from 0.15 mm to 5 mm. Within any of the foregoing ranges, the hollow fiber support layer can have (or achieve) suitable mechanical strength and sufficient water permeability. For example, in some embodiments, the hollow fiber support layer has a thickness of about 50 μm to about 200 μm. Preparation of composite membrane module

A composite membrane module may be prepared by forming an active layer on a surface of the hollow fiber support layer potted in the housing of the prepared single membrane module.

In one embodiment, the surface of the hollow fiber support layer potted in the prepared single membrane module is brought into contact with a first solution including an amine and then the surface is brought into contact with a second solution including an acyl halide (e.g., the contact between the surface and the first and second solutions occurs in the stated order). As described above, when the first and second solutions contact the surface of the hollow fiber support layer in that order, interfacial polymerization is performed on the surface of the hollow fiber support layer, and an active layer may be formed on the surface of the hollow fiber support layer by interfacial polymerization.

According to embodiments of the present invention, moisture and/or bubbles are removed (or substantially removed) from inside the hollow fiber support layer before the surface contacts the first solution to facilitate circulation of the first solution inside the hollow fiber of the module. For this purpose, air may be injected into the hollow fiber support layer before the surface of the hollow fiber support layer contacts the first solution. In addition, the remaining first solution may be removed by injecting air into the hollow fiber support layer after circulation of the first solution and before the surface of the hollow fiber support layer contacts the second solution to impart surface smoothness to the inner circumferential surface of the hollow fiber support layer.

Further, to prevent the hollow fiber from drying (or to reduce an amount of drying), the hollow fiber may be hydrophilized using an aqueous solution at about 30° C. to about 70° C. for about 1 hour to about 24 hours, before interfacial polymerization is performed using the first and second solutions or before the hollow fiber is potted to the module. The aqueous solution may include about 10 wt % to about 50 wt % of glycerin, based on the total weight of the aqueous solution.

As described above, when the coating of the surface of the hollow fiber support layer is performed by injecting the first and second solutions into the module after the single membrane module including the hollow fiber support layer is prepared, coating layers can be uniformly formed on the surfaces of the plurality of hollow fiber support layers potted inside the membrane module. Additionally, active layers having a uniform thickness can be formed on the surfaces of the hollow fiber support layers after coagulating the hollow fibers to form the hollow fiber support layers.

The surface of the hollow fiber support layer, on which the coating layers of the first and second solutions are formed, may be the inner or outer circumferential surface thereof.

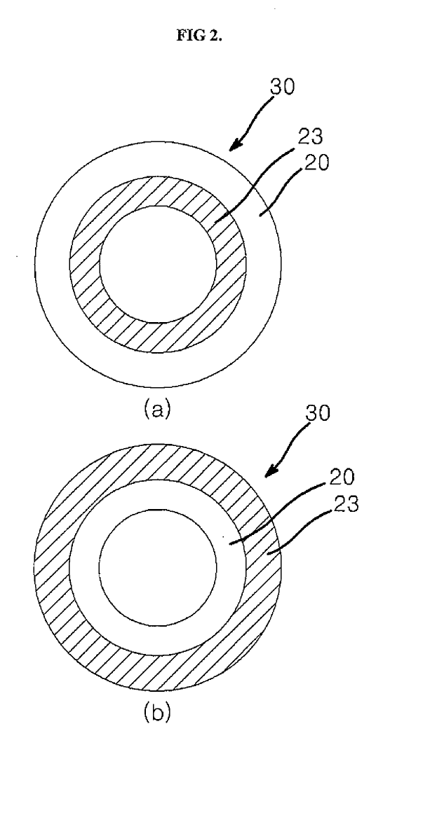

FIG. 2(a) shows a cross-sectional view of a composite membrane 30 including an active layer 23 on (or formed on) an inner circumferential surface of a hollow fiber support layer 20 in a composite membrane module according to one embodiment of the invention. In this embodiment, the inner circumferential surface of the hollow fiber support layer may be uniformly coated by circulation of the first and second solutions to be brought into contact with the module for about 1 minute to about 60 minutes under a pressure of about 0.1 atm to about 10 atm and blowing air. Air bubbles may be removed from the hollow fiber support layer before injection of the first and second solutions into the hollow fiber support layer.

FIG. 2(b) schematically shows a cross-sectional view of a composite membrane 30 including an active layer 23 on (or formed on) an outer circumferential surface of a hollow fiber support layer 20 in a composite membrane module according to another embodiment of the invention. In this embodiment, the outer circumferential surface of the porous hollow fiber support layer may be uniformly coated with the active layer by injecting the first and second solutions into the module and forming turbulent flow under a pressure of about 0.1 atm to about 10 atm. Before injecting the first and second solutions into the hollow fiber support layer, air bubbles may be removed from the hollow fiber support layer.

The active layer on (or formed on) the hollow fiber support layer may include a polyamide resin. In this manner, because the active layer includes the polyamide resin, the composite membrane can provide (or secure) a higher salt rejection rate than a conventional single membrane that is prepared from cellulose triacetate and exhibits a low salt rejection rate.

In one embodiment, the active layer including a polyamide may be formed by interfacial polymerization of the first and second solutions on the surface of the hollow fiber support layer, which includes a polysulfone resin (e.g., a polysulfone polymer).

For example, in one embodiment, a hydrophilized polysulfone hollow fiber support layer is brought into contact with the first solution, which includes an amine, followed by bringing the hydrophilized polysulfone hollow fiber support layer containing the first solution into contact with the second solution, which includes a polyfunctional acyl halide. This enables interfacial polymerization to be performed, thereby forming the active layer including a polyamide on the surface of the hydrophilized polysulfone hollow fiber support layer.

In some embodiments, the first solution includes a polyamine and water. The polyamine may include phenylenediamine, cyclohexanediamine, piperazine, or a mixture thereof, but the polyamine is not limited thereto. The polyamine may be present in the first solution in an amount of about 0.1 wt % to about 15 wt %, based on a total weight of the first solution. In addition, the first solution may further include a polar solvent. Nonlimiting examples of the polar solvent include ethylene glycol derivatives, propylene glycol derivatives, 1,3-propanediol derivatives, sulfoxide derivatives, sulfone derivatives, nitrile derivatives, ketone derivatives, urea derivatives, and the like, and mixtures thereof.

In some embodiments, the second solution includes a polyfunctional acyl halide and an organic solvent. The polyfunctional acyl halide may include trimesoyl chloride, isophthaloyl chloride, terephthaloyl chloride, 1,3,5-cyclohexane tricarbonyl chloride, 1,2,3,4-cyclohexane tetracarbonyl chloride, 1,3,5-benzenetricarbonyl trichloride, or the like, but the polyfunctional acyl halide is not limited thereto. The foregoing may be used alone or in a combination thereof. For example, in one embodiment, the polyfunctional acyl halide is trimesoyl chloride, which provides a good salt rejection rate. The polyfunctional acyl halide may be present in the second solution in an amount of about 0.01 wt % to about 5 wt %, based on a total weight of the second solution. In addition, the organic solvent may be a C₅ to C₁₂ aliphatic hydrocarbon, but the organic solvent is not limited thereto. Each coating time for interfacial polymerization may be about 10 minutes to about 20 minutes. Within the foregoing range, uniform coating may be achieved, and outside of the foregoing range, the active layer may have excess thickness.

The active layer formed by interfacial polymerization may have a thickness of about 0.01 μm to about 2 μm. Within the foregoing range, the composite membrane has a water permeability that is not too low and has a salt rejection rate that is suitable (or necessary) for effective membrane separation. For example, the active layer has a thickness of about 0.05 μm to about 0.5 μm.

The active layer may have a symmetric or asymmetric structure, and a pore size of about 0.001 μm to about 0.0001 μm.

A composite membrane module prepared by the aforementioned method may be used as a forward osmosis pressurizing membrane module. Embodiments of the composite membrane module exhibit a good salt rejection rate because the active layer of the composite membrane potted inside the housing has a uniform thickness. For example, the composite membrane module may have a salt rejection rate of about 90% to about 99.9%.

Hereinafter, embodiments of the present invention will be described with reference to some examples. However, it should be noted that these examples are provided for illustration only and are not to be construed in any way as limiting the present invention. Example

16 wt % to 20 wt % of a polysulfone, 69 wt % to 73 wt % of N-methyl-2-pyrrolidone (NMP), and 7 wt % to 11 wt % of a polyvinylpyrrolidone (PVP) were mixed, followed by preparation of a polymer solution at 60° C. for 24 hours. Each of the foregoing wt % is based on the total weight of the polymer solution. After removal of bubbles, the polymer solution was spun, to form hollow fibers. The hollow fibers were placed in air for 2.5 sec and dipped into water to form external and internal pores. Then, the hollow fibers were coagulated in water, thereby preparing a hollow fiber support layer.

The prepared hollow fiber support layer had an outer diameter (OD) of 0.7 mm to 1.3 mm, an inner diameter (ID) of 0.5 mm to 1.0 mm, and a thickness of 0.1 mm to 0.15 mm.

After the prepared hollow fiber support layer was potted to a module, a first solution (i.e., an aqueous solution of 2% m-phenylenediamine (MPD)) was pressurized to 1 atm and injected into the hollow fiber support layer, followed by circulation for 10 minutes. After circulation of the first solution, a second solution (i.e., an organic solution of 0.1 wt % 1,3,5-benzenetricarbonyl trichloride (TMC)) was pressurized to 1 atm, circulated for 10 minutes, and coated onto an inner circumferential surface of the hollow fiber support layer to form an active layer thereon, thereby preparing a composite membrane. The active layer of the composite membrane had a thickness of 0.2 μm to 0.3 μm, and a formed pore size of 0.001 μm to 0.0001 μm.

The salt rejection rate of the composite membrane was measured by the following method, and the results are shown in TABLE 1. From the results, it could be confirmed that the composite membrane prepared in the example exhibited a good salt rejection rate.

### Measurement of Salt Rejection Rate

Two to three composite membranes prepared as in the Example were placed in a transparent acrylic tube having a diameter of 1 cm, followed by sealing one end of each of the composite membranes and one end of the acrylic tube using a urethane resin. Then, with the other end of the acrylic tube remaining open, the other end of each of the composite membranes was sealed, thereby preparing a module for evaluation.

Raw water having a raw water concentration C (feed) of 2000 ppm NaCl was prepared, and introduced into the module for evaluation using a pressurization of 15 atm, and a salt concentration C (permeation) of treated water provided by the module was measured. The salt rejection rate was calculated according to the following equation:

Salt rejection rate (%)=[1-C (permeation)/C (feed)]×100

TABLE 1

| | Flow rate (LMH) | Salt rejection rate (%) |
|---|---|---|
| Example | 25 to 30 | 95 to 97 |

While certain embodiments of the present invention have been illustrated and described herein, it will be understood that various modifications, changes, alterations, and equivalent embodiments can be made by those skilled in the art without departing from the spirit and scope of the invention as defined by the following claims, and equivalents thereof. Throughout the text and claims, use of the word “about” reflects the penumbra of variation associated with measurement, significant figures, and interchangeability, all as understood by a person having ordinary skill in the art to which this disclosure pertains. Additionally, throughout this disclosure and the accompanying claims, it is understood that even those ranges that may not use the term “about” to describe the high and low values are also implicitly modified by that term, unless otherwise specified.

What is claimed is:

1. A method of preparing a composite membrane module, comprising:
preparing a single membrane module comprising a hollow fiber support layer potted in the single membrane module; and
forming an active layer on a surface of the hollow fiber support layer through interfacial polymerization by bringing the surface of the hollow fiber support layer into contact with a first solution comprising an amine and then bringing the surface of the hollow fiber support layer into contact with a second solution comprising an acyl halide.

2. The method according to claim 1, wherein the single membrane module comprises:
a plurality of hollow fiber support layers, each of the plurality of hollow fiber support layers being potted at two ends thereof; and
a housing accommodating the plurality of hollow fiber support layers therein.

3. The method according to claim 1, wherein the hollow fiber support layer is prepared by:
forming hollow fibers by spinning a polymer solution comprising a polysulfone resin, an organic solvent, and a pore agent;
forming external pores in the hollow fibers by exposing the hollow fibers to air;
forming internal pores in the hollow fibers by dipping the hollow fibers having the external pores into a non-solvent; and
coagulating the hollow fibers.

4. The method according to claim 3, wherein the polysulfone resin comprises polysulfone, polyether sulfone, or a mixture thereof.

5. The method according to claim 3, wherein the organic solvent comprises N,N-dimethylformamide, N-methyl-2-pyrrolidone, dimethyl sulfoxide, dimethylacetamide, or a mixture thereof.

6. The method according to claim 3, wherein the pore agent comprises 2-ethoxyethanol, propionic acid, acetic acid, t-amyl alcohol, 2-methoxyethanol, methanol, ethanol, butanol, isopropyl alcohol, polyethylene glycol, silica, polyvinylpyrrolidone or a mixture thereof.

7. The method according to claim 3, wherein the non-solvent comprises water, methanol, ethanol, isopropanol, or a mixture thereof.

8. The method according to claim 1, wherein the hollow fiber support layer has an inner diameter of about 0.1 mm to about 3.0 mm, and a thickness of about 10 μm to about 500 μm.

9. The method according to claim 1, wherein the hollow fiber support layer is a porous ultrafiltration membrane having a pore size of about 10 nm to about 100 μm.

10. The method according to claim 1, wherein the active layer has a pore size of about 0.001 μm to about 0.0001 μm.

11. The method according to claim 1, wherein the first solution comprises a polyamine and water, and the polyamine is present in the first solution in an amount of about 0.1 wt % to about 15 wt %, based on 100 wt % of the first solution.

12. The method according to claim 11, wherein the polyamine comprises phenylenediamine, cyclohexanediamine, piperazine, or a mixture thereof.

13. The method according to claim 1, wherein the second solution comprises a polyfunctional acyl halide and an organic solvent, and the polyfunctional acyl halide is present in the second solution in an amount of about 0.01 wt % to about 5 wt %, based on 100 wt % of the second solution.

14. The method according to claim 13, wherein the polyfunctional acyl halide comprises trimesoyl chloride, isophthaloyl chloride, terephthaloyl chloride, 1,3,5-cyclohexane tricarbonyl chloride, 1,2,3,4-cyclohexane tetracarbonyl chloride, 1,3,5-benzenetricarbonyl trichloride or a mixture thereof.

15. The method according to claim 1, wherein the composite membrane module is a pressurizing module.

16. A composite membrane module prepared according to the method of claim 1, and having a salt rejection rate of about 90% to about 99%.
